(19) United States
(12) Patent Application Publication
(10) Pub. No.: US 2024/0098707 A1
(43) Pub. Date: Mar. 21, 2024

(54) INDICATING NETWORK STATE VIA BANDWIDTH PART FRAMEWORK

(71) Applicant: QUALCOMM Incorporated, San Diego, CA (US)

(72) Inventors: Ahmed Attia ABOTABL, San Diego, CA (US); Hung Dinh LY, San Diego, CA (US); Yu ZHANG, San Diego, CA (US); Krishna Kiran MUKKAVILLI, San Diego, CA (US); Wanshi CHEN, San Diego, CA (US)

(21) Appl. No.: 17/933,956

(22) Filed: Sep. 21, 2022

(51) Int. Cl. H04W 72/04; H04L 5/14; H04W 76/20

(52) U.S. Cl. CPC H04W 72/044; H04L 5/1469; H04W 72/042; H04W 76/20

(57) ABSTRACT

Various aspects of the present disclosure generally relate to wireless communication. In some aspects, a network node may transmit, and a user equipment (UE) may receive, information that configures a periodic bandwidth part (BWP) switching pattern that indicates a sequence of BWPs, wherein each BWP in the sequence of BWPs is associated with a respective network state. The UE and the network node may communicate according to the periodic BWP switching pattern, wherein the UE and the network node may communicate by sequentially switching among the BWPs in the sequence of BWPs indicated in the periodic BWP switching pattern, wherein each BWP in the sequence of BWPs is associated with a configuration corresponding to the respective network state associated with the BWP. Numerous other aspects are provided.

### FIELD OF THE DISCLOSURE

Aspects of the present disclosure generally relate to wireless communication and specifically, to techniques and apparatuses associated with indicating a network state via a bandwidth part (BWP) framework.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipment (UE) to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

For various reasons, including climate change mitigation, environmental sustainability, and network cost reduction, network energy saving and/or network energy efficiency measures are expected to have increased importance in wireless network operations. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, which could potentially lead to a more efficient wireless network that nonetheless has higher energy requirements and/or causes more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). Most energy consumption and/or energy costs are associated with powering a radio access network (RAN), which accounts for about half of the energy consumed by a wireless network. Accordingly, measures to increase network energy savings and/or network energy efficiency are important factors that may drive adoption and/or expansion of wireless networks.

One way to increase energy efficiency in a RAN may be to adapt network energy consumption models to achieve more efficient operation dynamically and/or semi-statically. For example, power consumption in a RAN can generally be split into a dynamic portion, in which power is consumed only when data transmission and/or reception is ongoing, and a static portion, in which power is consumed all of the time to maintain the operation of radio access devices even when data transmission and/or reception is not ongoing. Accordingly, one potential approach to improve network energy savings may be to adapt power consumption models from the network perspective by reducing relative energy consumption for downlink and/or uplink communication (for example, considering factors such as power amplifier (PA) efficiency, quantities of transceiver units (TxRUs), and/or network load, among other examples), enabling network sleep states and associated transition times, and/or defining appropriate reference parameters and/or configurations. For example, in some cases, different network energy saving (NES) states may be configured to enable granular adaptation of transmission and/or reception to reduce energy consumption using techniques in time, frequency, spatial, and/or power domains, with potential support and/or feedback from UEs and/or potential UE assistance information. However, network devices and UEs may need to exchange and/or coordinate information over network interfaces to control configurations, communication parameters, and/or UE behavior for each NES state, which can increase configuration complexity and/or signaling overhead.

### SUMMARY

Some aspects described herein relate to a method of wireless communication performed by a user equipment (UE). The method may include receiving, from a network node, information that configures a periodic bandwidth part (BWP) switching pattern that indicates a sequence of BWPs, wherein each BWP in the sequence of BWPs is associated with a respective network state. The method may include communicating with the network node according to the periodic BWP switching pattern, wherein communicating with the network node includes, sequentially switching among the BWPs in the sequence of BWPs indicated in the periodic BWP switching pattern, where each BWP used to communicate with the network node is associated with a configuration corresponding to the respective network state associated with the BWP.

Some aspects described herein relate to a method of wireless communication performed by a network node. The method may include transmitting, to a UE, information that configures a periodic BWP switching pattern that indicates a sequence of BWPs, wherein each BWP in the sequence of BWPs is associated with a respective network state. The method may include communicating with the UE according to the periodic BWP switching pattern, wherein communicating with the UE includes, sequentially switching among the BWPs in the sequence of BWPs indicated in the periodic BWP switching pattern, where each BWP used to communicate with the UE is associated with a configuration corresponding to the respective network state associated with the BWP.

Some aspects described herein relate to a UE for wireless communication. The UE may include at least one processor and at least one memory, communicatively coupled with the at least one processor, that stores processor-readable code. The processor-readable code, when executed by the at least one processor, may be configured to cause the user equipment to receive, from a network node, information that configures a periodic BWP switching pattern that indicates a sequence of BWPs, wherein each BWP in the sequence of BWPs is associated with a respective network state. The processor-readable code, when executed by the at least one processor, may be configured to cause the user equipment to communicate with the network node according to the periodic BWP switching pattern, wherein, to cause the UE to communicate with the network node, the at least one processor is configured to cause the UE.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit, to a UE, information that configures a periodic BWP switching pattern that indicates a sequence of BWPs, wherein each BWP in the sequence of BWPs is associated with a respective network state. The processor-readable code, when executed by the at least one processor, may be configured to cause the network node to communicate with the UE according to the periodic BWP switching pattern, wherein, to cause the network node to communicate with the UE, the at least one processor is configured to cause the network node.

Some aspects described herein relate to a non-transitory computer-readable medium that stores a set of instructions for wireless communication by a UE. The set of instructions, when executed by one or more processors of the UE, may cause the UE to receive, from a network node, information that configures a periodic BWP switching pattern that indicates a sequence of BWPs, wherein each BWP in the sequence of BWPs is associated with a respective network state. The set of instructions, when executed by one or more processors of the UE, may cause the UE to communicate with the network node according to the periodic BWP switching pattern, wherein communicating with the network node includes.

Some aspects described herein relate to a non-transitory computer-readable medium that stores a set of instructions for wireless communication by a network node. The set of instructions, when executed by one or more processors of the network node, may cause the network node to transmit, to a UE, information that configures a periodic BWP switching pattern that indicates a sequence of BWPs, wherein each BWP in the sequence of BWPs is associated with a respective network state. The set of instructions, when executed by one or more processors of the network node, may cause the network node to communicate with the UE according to the periodic BWP switching pattern, wherein communicating with the UE includes.

Some aspects described herein relate to an apparatus for wireless communication. The apparatus may include means for receiving, from a network node, information that configures a periodic BWP switching pattern that indicates a sequence of BWPs, wherein each BWP in the sequence of BWPs is associated with a respective network state. The apparatus may include means for communicating with the network node according to the periodic BWP switching pattern, wherein communicating with the network node includes, means for sequentially switching among the BWPs in the sequence of BWPs indicated in the periodic BWP switching pattern, where each BWP used to communicate with the network node is associated with a configuration corresponding to the respective network state associated with the BWP.

Some aspects described herein relate to an apparatus for wireless communication. The apparatus may include means for transmitting, to a UE, information that configures a periodic BWP switching pattern that indicates a sequence of BWPs, wherein each BWP in the sequence of BWPs is associated with a respective network state. The apparatus may include means for communicating with the UE according to the periodic BWP switching pattern, wherein communicating with the UE includes, means for sequentially switching among the BWPs in the sequence of BWPs indicated in the periodic BWP switching pattern, where each BWP used to communicate with the UE is associated with a configuration corresponding to the respective network state associated with the BWP.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example of network operations to reduce energy consumption in accordance with the present disclosure.

FIG. 4 is a diagram illustrating an example associated with indicating a network state via a bandwidth part framework in accordance with the present disclosure.

FIG. 5 is a flowchart illustrating an example process performed, for example, by a UE in accordance with the present disclosure.

FIG. 6 is a flowchart illustrating an example process performed, for example, by a network node in accordance with the present disclosure.

FIGS. 7-8 are diagrams of example apparatuses for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to indicating a periodic sequence of network energy saving (NES) states using a bandwidth part (BWP) framework. Some aspects more specifically relate to operating a network node in various NES states (for example, a default or normal mode and one or more sleep or low power modes associated with configurations to save power and maintain network operation) and configuring a periodic BWP switching pattern to indicate changes to the NES state in which the network node is operating at any given time. For example, in some aspects, a candidate BWP may be associated with one or more configurations, communication parameters, and/or user equipment (UE) behaviors associated with one or more NES states, whereby the periodic BWP switching pattern may be used to enable switching among different NES states. For example, the network node may configure the UE with one or more candidate BWPs and may configure the UE with the periodic BWP switching pattern to indicate a sequence of candidate BWPs and/or a sequence of configurations associated with a candidate BWP that the network node and the UE are configured to follow when communicating on a downlink and/or an uplink. Furthermore, each candidate BWP and/or each configuration associated with a candidate BWP in the sequence of candidate BWPs may be associated with a duration that the respective candidate BWP and/or BWP configuration is to remain active. Accordingly, in some aspects, the network node and the UE may sequentially switch between different BWPs and/or different BWP configurations according to the periodic BWP switching pattern to sequentially switch between different NES states.

Particular aspects of the subject matter described in this disclosure can be implemented to realize one or more of the following potential advantages. In some examples, the described techniques can be used to configure a semi-static approach to reduce network energy consumption by associating each candidate BWP or candidate BWP configuration in a periodic BWP switching pattern with a corresponding NES state. Furthermore, in some examples, the described techniques can be used to avoid configuring and/or signaling NES states, because the candidate BWP or candidate BWP configuration carries the configurations, communication parameters, and/or UE behaviors to realize the corresponding NES state. Furthermore, in some examples, the described techniques can be used to avoid reliance on dynamic BWP switching to change between different candidate BWPs and/or different candidate BWP configurations, which tends to carry significant overhead from a signaling and/or UE processing perspective.

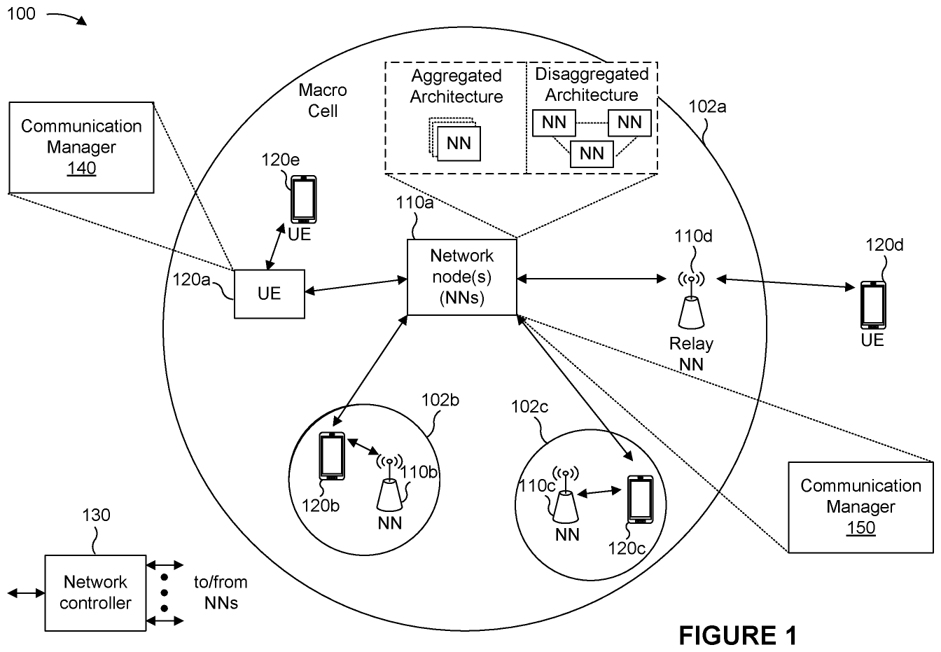

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node 110, information that configures a periodic BWP switching pattern that indicates a sequence of BWPs, wherein each BWP in the sequence of BWPs is associated with a respective network state; and communicate with the network node 110 according to the periodic BWP switching pattern, wherein, to communicate with the network node 110, the communication manager 140 may sequentially switch among the BWPs in the sequence of BWPs indicated in the periodic BWP switching pattern, wherein each BWP used to communicate with the network node 110 is associated with a configuration corresponding to the respective network state associated with the BWP. Additionally or alternatively, the communication manager 140 may perform one or more other operations described herein.

In some aspects, the network node 110 may include a communication manager 150. As described in more detail elsewhere herein, the communication manager 150 may transmit, to a UE 120, information that configures a periodic BWP switching pattern that indicates a sequence of BWPs, wherein each BWP in the sequence of BWPs is associated with a respective network state; and communicate with the UE 120 according to the periodic BWP switching pattern, wherein to communicate with the UE 120, the communication manager 150 may sequentially switch among the BWPs in the sequence of BWPs indicated in the periodic BWP switching pattern, wherein each BWP used to communicate with the UE 120 is associated with a configuration corresponding to the respective network state associated with the BWP. Additionally or alternatively, the communication manager 150 may perform one or more other operations described herein.

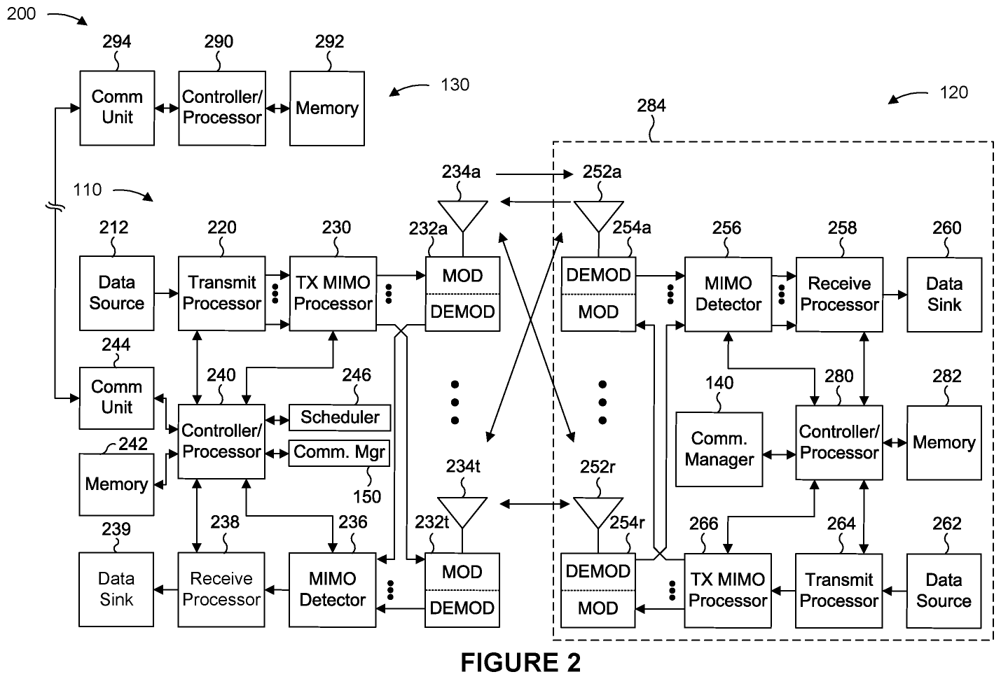

FIG. 2 is a diagram illustrating an example 200 of a network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

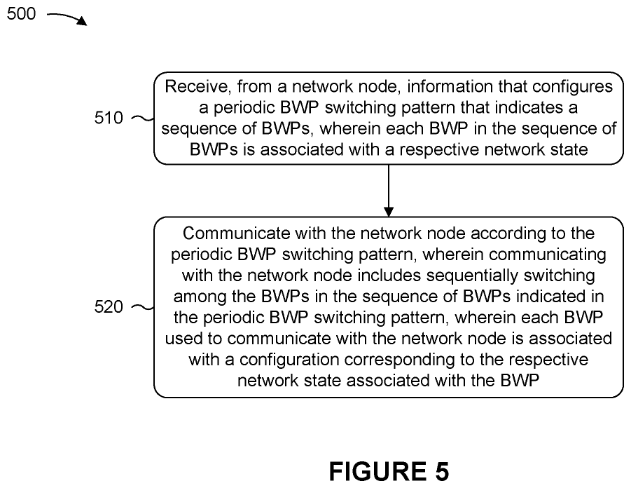

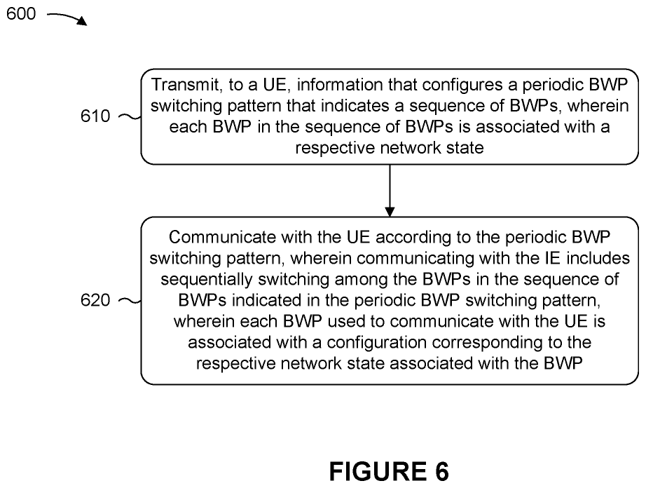

The controller/processor 240 of the network node 110, the controller/processor 280 of the UE 120, or any other component(s) of FIG. 2 may perform one or more techniques associated with indicating a network state via a BWP framework, as described in more detail elsewhere herein. For example, the controller/processor 240 of the network node 110, the controller/processor 280 of the UE 120, or any other component(s) of FIG. 2 may perform or direct operations of, for example, process 500 of FIG. 5, process 600 of FIG. 6, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 500 of FIG. 5, process 600 of FIG. 6, or other processes as described herein. In some examples, executing instructions may include running the instructions, converting the instructions, compiling the instructions, or interpreting the instructions, among other examples.

In some aspects, the UE 120 includes means for receiving, from a network node 110, information that configures a periodic BWP switching pattern that indicates a sequence of BWPs, wherein each BWP in the sequence of BWPs is associated with a respective network state; and/or means for communicating with the network node 110 according to the periodic BWP switching pattern, wherein the means for communicating with the network node 110 includes: means for sequentially switching among the BWPs in the sequence of BWPs indicated in the periodic BWP switching pattern, wherein each BWP used to communicate with the network node 110 is associated with a configuration corresponding to the respective network state associated with the BWP. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, information that configures a periodic BWP switching pattern that indicates a sequence of BWPs, wherein each BWP in the sequence of BWPs is associated with a respective network state; and/or means for communicating with the UE 120 according to the periodic BWP switching pattern, wherein the means for communicating with the UE includes: means for sequentially switching among the BWPs in the sequence of BWPs indicated in the periodic BWP switching pattern, wherein each BWP used to communicate with the UE 120 is associated with a configuration corresponding to the respective network state associated with the BWP. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

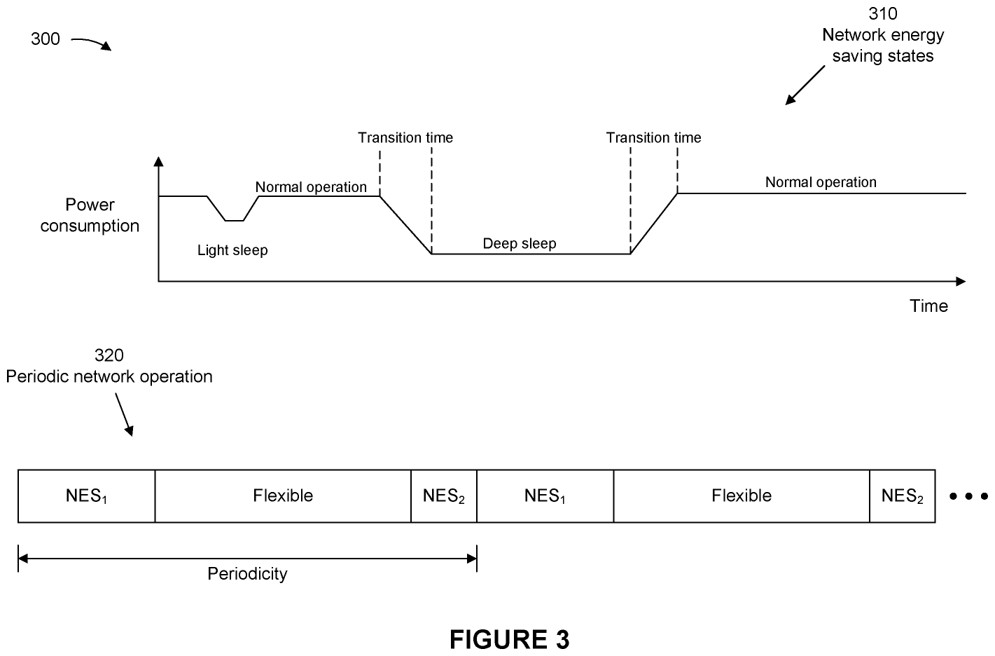

FIG. 3 is a diagram illustrating an example 300 of network operations to reduce energy consumption in accordance with the present disclosure. Network energy saving and/or network energy efficiency measures are expected to have increased importance in wireless network operations for various reasons, including climate change mitigation, environmental sustainability, and network cost reduction. For example, although NR generally offers a significant energy efficiency improvement per gigabyte over previous generations (for example, LTE), new NR use cases that demand high data rates and/or the adoption of millimeter wave frequencies may require more network sites, greater network density, more network antennas, larger bandwidths, and/or more frequency bands, which could potentially lead to a more efficient wireless network that nonetheless has higher energy requirements and/or causes more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). Most energy consumption and/or energy costs come from powering a RAN, which accounts for about half of the energy consumed by a wireless network. Accordingly, measures to increase network energy savings and/or network energy efficiency are important factors that may drive adoption and/or expansion of wireless networks.

One way to increase energy efficiency in a RAN may be to adapt network energy consumption models to achieve more efficient operation dynamically and/or semi-statically. For example, power consumption in a RAN can generally be split into a dynamic portion, in which power is consumed only when data transmission and/or reception is ongoing, and a static portion, in which power is consumed all of the time to maintain the operation of radio access devices even when data transmission and/or reception is not ongoing. Accordingly, one potential approach to improve network energy savings may be to adapt power consumption models from the network perspective by reducing relative energy consumption for downlink and/or uplink communication (for example, considering factors such as power amplifier (PA) efficiency, quantities of transceiver units (TxRUs), and/or network load, among other examples), enabling network sleep states and associated transition times, and/or defining appropriate reference parameters and/or configurations. For example, in some cases, different NES states may be configured to enable granular adaptation of transmission and/or reception to reduce energy consumption using techniques in time, frequency, spatial, and/or power domains, with potential support and/or feedback from UEs and/or potential UE assistance information. However, network devices and UEs may need to exchange and/or coordinate information over network interfaces to control configurations, communication parameters, and/or UE behavior for each NES state, which can increase configuration complexity and/or signaling overhead. This may pose challenges because techniques to reduce network energy consumption should generally be designed to avoid having a large impact on key performance indicators (KPIs) related to network and/or UE performance (for example, spectral efficiency, latency, UE power consumption, and/or complexity, among other examples).

Accordingly, as shown in FIG. 3, a network node may be configured to operate in different NES states 310 over time, where each NES state 310 may use one or more techniques to adapt transmission and/or reception in time, frequency, spatial, and/or power domains. For example, as shown in FIG. 3, the NES states 310 may include a normal operation mode (which may also be referred to as a legacy mode or a default mode) and one or more sleep modes that may be associated with a lower power consumption than the normal operation mode. In general, a network node may transition between different NES states 310 to save power and maintain network operation (for example, minimizing impact on KPIs such as spectral efficiency, capacity, user perceived throughput (UPT), latency, UE power consumption, complexity, handover performance, call drop rate, initial access performance, and/or SLA assurance). Furthermore, the network node may transition between different sleep modes based on traffic demands (for example, entering a light sleep mode when traffic demands are slightly lower than usual and/or entering a deep sleep mode when traffic demands are much lower than usual), and different sleep modes may be associated with different energy saving techniques (for example, one or more antenna panels, antenna ports, and/or radio frequency (RF) chains may be turned off in the deep sleep mode but remain on in the light sleep mode). Accordingly, as shown in FIG. 3, the normal operation mode and the different sleep modes may vary in terms of power consumption and may be associated with different transition times (for example, a transition time to or from the deep sleep mode may be longer than a transition time to or from the light sleep mode).

In some cases, as described herein, an NES state 310 may generally correspond to a particular set of configurations, communication parameters, and/or UE behaviors. For example, an NES state 310 may include a set of configurations, communication parameters, and/or UE behaviors associated with one or more energy saving techniques that are implemented in the time, frequency, spatial, and/or power domain to reduce energy consumption. For example, a network node may be configured to not transmit a synchronization signal block (SSB) to reduce energy consumption in a first NES state 310 (for example, an SSB-less NES state 310), and may be configured to employ other energy saving techniques such as turning off one or more antenna panels in a second NES state 310. Furthermore, in some cases, an NES state 310 may be associated with a set of configurations, communication parameters, and/or UE behaviors associated with the normal or legacy mode of network operation. Accordingly, because one design objective in energy-efficient wireless networks is to achieve more efficient operation dynamically and/or semi-statically, a network node may configure a semi-static pattern 320 to achieve network energy savings. For example, as shown in FIG. 3, the semi-static pattern 320 (for example, configured via radio resource control (RRC) signaling) may include a sequence of NES states 310 that the network node follows in accordance with a given periodicity (for example, in FIG. 3, the network node operates in accordance with a first NES state, shown as NES₁, for a first time period, then operates in a flexible mode for a second time period, then operates in accordance with a second NES state, shown as NES₂, for a third time period, and the pattern then repeats). In cases where the semi-static pattern 320 includes a flexible mode, the network node may operate in accordance with any suitable NES state during the time period corresponding to the flexible mode (for example, depending on current traffic conditions), and the NES state that the network node selects for the time period corresponding to the flexible mode may be dynamically indicated to served UEs.

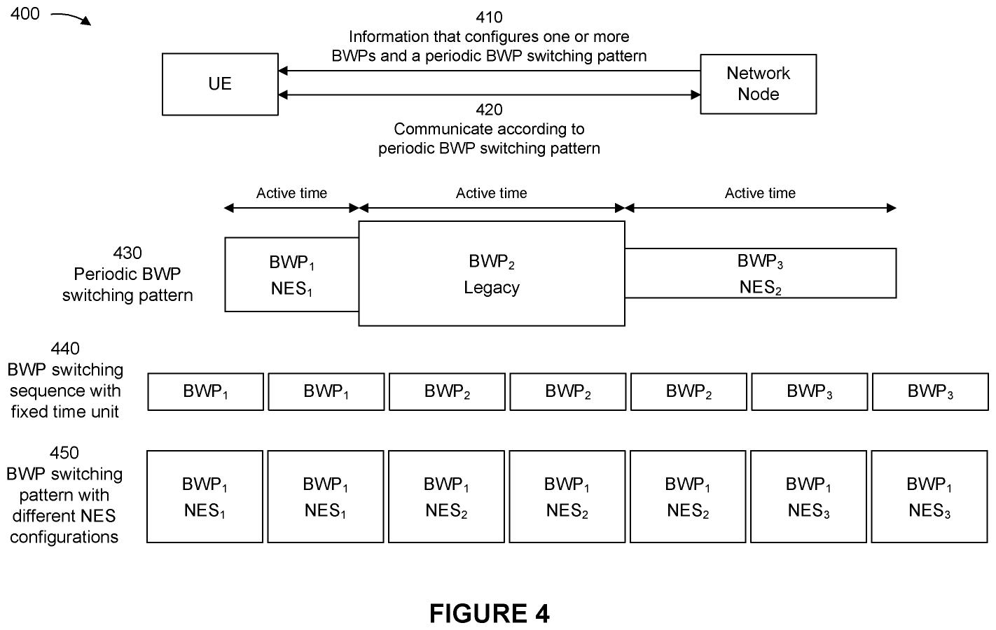

However, in order to configure a semi-static pattern 320 to switch between different NES states, a network node may need to configure each NES state for served UEs and may need to configure various parameters associated with the semi-static pattern 320 (for example, the sequence of NES states included in the semi-static pattern 320 and/or the periodicity of the semi-static pattern 320), which can increase configuration complexity and/or signaling overhead. Accordingly, various aspects described herein relate generally to indicating a periodic sequence of NES states using a BWP framework. Some aspects more specifically relate to operating a network node in various NES states (for example, a default or normal mode and one or more sleep or low power modes associated with configurations to save power and maintain network operation) and configuring a periodic BWP switching pattern to indicate changes to the NES state in which the network node is operating at any given time. For example, in some aspects, a candidate BWP may be associated with one or more configurations, communication parameters, and/or UE behaviors associated with one or more NES states, whereby the periodic BWP switching pattern may be used to enable switching among different NES states. For example, the network node may configure the UE with one or more candidate BWPs and may configure the UE with the periodic BWP switching pattern to indicate a sequence of candidate BWPs and/or a sequence of configurations associated with a candidate BWP that the network node and the UE are configured to follow when communicating on a downlink and/or an uplink. Furthermore, each candidate BWP and/or each configuration associated with a candidate BWP in the sequence of candidate BWPs may be associated with a duration that the respective candidate BWP and/or BWP configuration is to remain active. Accordingly, as described in further detail herein with reference to FIG. 4, the network node and the UE may sequentially switch between different BWPs and/or different BWP configurations according to the periodic BWP switching pattern to sequentially switch between different NES states.

FIG. 4 is a diagram illustrating an example 400 associated with indicating a network state via a BWP framework in accordance with the present disclosure. As shown in FIG. 4, example 400 includes communication between a network node (for example, network node 110) and a UE (for example, UE 120). In some aspects, the network node and the UE may communicate in a wireless network, such as wireless network 100. The network node and the UE may communicate via a wireless access link, which may include an uplink and a downlink.

As shown in FIG. 4, in a first operation 410, the network node may transmit, and the UE may receive, information that configures one or more BWPs and information that configures a periodic BWP switching pattern that indicates a sequence of BWPs. For example, as described herein, each BWP in the sequence of BWPs may be associated with a respective network state, which correspond to an NES state, a legacy or normal state, and/or a flexible mode in which the corresponding network state can be dynamically configured and indicated to the UE (for example, the flexible mode may be configured to operate in accordance with any suitable NES state and/or the legacy or normal mode depending on traffic conditions). For example, in some aspects, each BWP configured by the network node may be associated with one or more communication parameters that correspond to a particular NES state, or a particular BWP configured by the network node may be associated with multiple configurations that each correspond to a different NES state. Accordingly, as described herein, the periodic BWP switching pattern may generally indicate the sequence of BWPs that the UE and the network node are to use to communicate via the wireless access link along with a duration that each BWP in the sequence of BWPs is to remain active. Accordingly, in a second operation 420, the UE and the network node may communicate according to the periodic BWP switching pattern, which may include sequentially switching among the BWPs in the sequence of BWPs indicated in the periodic BWP switching pattern. In this way, because each BWP in the BWP switching pattern is associated with a configuration that corresponds to a respective network state, the periodic BWP switching pattern may be used to switch between different network states without the network node having to configure the different network states and/or exchange signaling with the UE to configure a semi-static pattern for switching between the different network states (for example, aspects described herein may repurpose a BWP configuration and switching framework to enable configuration and switching for different network states).

For example, FIG. 4 depicts an example periodic BWP switching pattern 430 that configures the UE to communicate with the network node using a first BWP (shown as BWP₁) for a first duration, using a second BWP (shown as BWP₂) for a second duration, and using a third BWP (shown as BWP₃) for a third duration. As further shown, the first BWP is associated with a configuration corresponding to a first NES state (shown as NES₁) (for example, an SSB-less NES state), the second BWP is associated with a configuration corresponding to a legacy or normal mode, and the third BWP is associated with a configuration corresponding to a second NES state (shown as NES₂) (for example, an NES state in which one or more RF chains are turned off). Accordingly, the UE and the network node may sequentially switch between the different BWPs in the sequence, which may effectively realize sequential switching between the different NES states and the legacy or normal mode. Furthermore, the respective duration that each BWP is to remain an active BWP (shown in FIG. 4 as an active time) may be indicated as a quantity of transmission time intervals (for example, a quantity of symbols, slots, or frames), or as a time period (for example, a quantity of milliseconds or seconds). For example, in cases where the respective duration that each BWP is to remain the active BWP is indicated as a quantity of symbols, slots, or frames, the actual time period that each BWP remains active may be a function of a subcarrier spacing, which may differ across different BWPs (for example, a symbol duration is generally proportional to the subcarrier spacing, where a larger subcarrier spacing has a shorter symbol duration and vice versa). In this regard, a quantity of N symbols, slots, or frames could occupy a first duration in a first BWP and a second (for example, longer or shorter) duration in a second BWP. Accordingly, in some cases, the duration that each BWP remains the active BWP may be indicated according to a quantity of seconds or milliseconds to provide a uniform representation of time that is applicable to all BWPs in the sequence.

Additionally or alternatively, in some aspects, a fixed time unit may be defined (for example, in terms of symbols, slots, frames, or milliseconds/seconds), and the duration that each BWP is to remain active may be defined by the sequence of BWPs and the fixed time unit. For example, FIG. 4 depicts an example of a BWP switching sequence 440 in which each BWP is active for a duration that is based on a fixed unit, where the BWP switching sequence 440 shown in FIG. 4 may be indicated as [BWP1, BWP1, BWP2, BWP2, BWP2, BWP3, BWP3]. In this example, if the fixed time unit were to be configured as two (2) slots, the first BWP (BWP1) would be active for four (4) slots because the sequence starts with two instances of the first BWP, the second BWP (BWP2) would be active for six (6) slots because the sequence includes three instances of the second BWP following the two instances of the first BWP, and the third BWP (BWP3) would be active for four (4) slots because the sequence finishes with two instances of the third BWP. Notably, in this example, the actual time that the respective BWPs are active may be a function of the subcarrier spacing associated with each BWP. For example, although the first and third BWPs are both active for the same quantity of slots, the first and third BWPs may be active for different durations if the subcarrier spacings are different. In another example, although the second BWP is active for a larger number of slots than the first and third BWPs, the second BWP may be active for a shorter time than the first and/or third BWPs if the second BWP has a large subcarrier spacing that translates to a shorter symbol duration than the first and/or third BWPs. In a similar respect, if the fixed time unit is defined as a quantity of milliseconds or seconds, the quantity of transmission time intervals (for example, symbols, slots, or frames) that each BWP remains active may be a function of the respective subcarrier spacings.

In some aspects, as described herein, the periodic BWP switching pattern may indicate a sequence of BWPs, which may include different BWPs that are each associated with a different configuration corresponding to a different network state. However, when switching between different BWPs, which may have different center frequencies and/or different bandwidths, there is typically a switching delay associated with retuning RF components to fit the new center frequency and bandwidth of the new active BWP. However, because the periodic BWP switching pattern described herein is used to sequentially switch between different network states, some aspects described herein may associate a single BWP with multiple configurations that correspond to different network states, and the periodic BWP switching pattern may be used to sequentially switch between the multiple configurations of the underlying BWP and thereby avoid the switching delays that are otherwise associated with retuning RF components to fit a new center frequency and/or bandwidth. For example, FIG. 4 depicts an example of a periodic BWP switching pattern 450 where a single underlying BWP is associated with different configurations that correspond to different NES states. For example, a particular BWP (shown as BWP₁) may be associated with a first configuration corresponding to a first NES state (shown as NES₁), a second configuration corresponding to a second NES state (shown as NES₂), and a third configuration corresponding to a third NES state (shown as NES₃). In general, the underlying BWP associated with the different configurations may be a legacy BWP (for example, a BWP associated with a legacy or normal mode of operation, which can be reconfigured to realize an NES state), or the underlying BWP may be specifically configured for the purpose of switching between different configurations that correspond to different network states. Accordingly, when the UE and the network node sequentially switch among the BWPs in the sequence of BWPs, the UE and the network node may maintain the same center frequency and bandwidth and may switch among different BWP configurations only.

In some aspects, in order to configure the BWP switching pattern, the network node may transmit, to the UE, RRC signaling that configures one or more candidate BWPs and one or more configurations for each of the one or more candidate BWPs. In addition, the RRC signaling may configure multiple candidate BWP switching patterns that each include a respective sequence of candidate BWPs and corresponding durations, and each candidate BWP switching pattern may also be associated with a periodicity that defines how often the candidate BWP switching pattern repeats. Furthermore, in some aspects, one or more candidate BWP switching patterns can include a flexible BWP among the sequence of BWPs, where the flexible BWP is associated with a time division duplexing (TDD) pattern that can be dynamically indicated (for example, in contrast to a downlink-only or an uplink-only BWP). In some aspects, the flexible BWP may also be associated with a flexible mode, where the network node can dynamically indicate whether the flexible BWP is associated with the legacy or normal mode or an NES state (for example, by dynamically indicating the configuration of the flexible BWP, such as the quantity of active antenna units and/or whether SSBs are transmitted).

Accordingly, the network node may generally configure multiple candidate BWP switching patterns, and one of the candidate BWP switching patterns may be active at any given time. For example, after transmitting the RRC signaling to configure the candidate BWP switching patterns, the network node may transmit downlink control information (DCI) to indicate one of the candidate switching patterns. Additionally or alternatively, the network node may transmit a medium access control (MAC) control element (MAC-CE) to down-select the RRC-configured candidate BWP switching patterns, and the DCI may include a field to identify one of the candidate BWP switching patterns down-selected by the MAC-CE. For example, in some aspects, each BWP switching pattern that the network node configures using the RRC signaling may be associated with an identifier, and the DCI may indicate the identifier associated with one of the candidate BWP switching patterns that is currently active. For example, in some aspects, the DCI may include a two-bit field to indicate the BWP switching pattern. However, in some cases, the two-bit field may not provide sufficient flexibility to switch between different candidate BWP switching patterns (for example, where the quantity of candidate BWP switching patterns exceeds the quantity of candidate BWP switching patterns that can be indicated using two bits). In such cases, the switching between different candidate BWP switching patterns may be restricted (for example, via RRC signaling) depending on the current active BWP and/or the current BWP switching pattern. Additionally or alternatively, the DCI may include one or more additional bits to enable switching among the candidate BWP switching patterns.

FIG. 5 is a flowchart illustrating an example process 500 performed, for example, by a UE that supports a network state indication via a BWP framework in accordance with the present disclosure. Example process 500 is an example where the UE (for example, UE 120) performs operations associated with indicating a network state via a BWP framework.

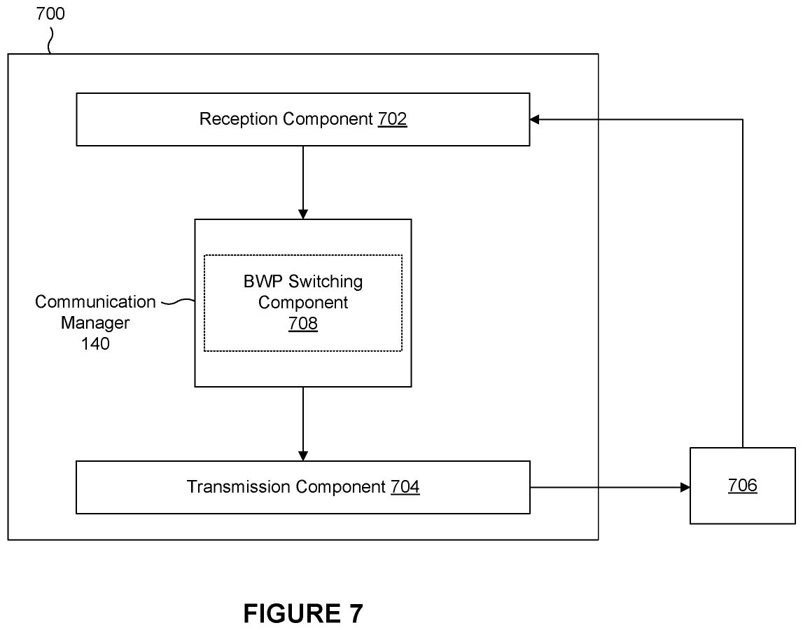

As shown in FIG. 5, in some aspects, process 500 may include receiving, from a network node, information that configures a periodic BWP switching pattern that indicates a sequence of BWPs, wherein each BWP in the sequence of BWPs is associated with a respective network state (block 510). For example, the UE (such as by using communication manager 140 or reception component 702, depicted in FIG. 7) may receive, from a network node, information that configures a periodic BWP switching pattern that indicates a sequence of BWPs, wherein each BWP in the sequence of BWPs is associated with a respective network state, as described above.

As further shown in FIG. 5, in some aspects, process 500 may include communicating with the network node according to the periodic BWP switching pattern, wherein communicating with the network node includes: sequentially switching among the BWPs in the sequence of BWPs indicated in the periodic BWP switching pattern, wherein each BWP used to communicate with the network node is associated with a configuration corresponding to the respective network state associated with the BWP (block 520). For example, the UE (such as by using communication manager 140, reception component 702, transmission component 704, and/or BWP switching component 708, depicted in FIG. 7) may communicate with the network node according to the periodic BWP switching pattern, wherein communicating with the network node includes: sequentially switching among the BWPs in the sequence of BWPs indicated in the periodic BWP switching pattern, wherein each BWP used to communicate with the network node is associated with a configuration corresponding to the respective network state associated with the BWP, as described above.

Process 500 may include additional aspects, such as any single aspect or any combination of aspects described below or in connection with one or more other processes described elsewhere herein.

In a first additional aspect, the periodic BWP switching pattern indicates respective durations that each BWP in the sequence of BWPs is configured to be an active BWP.

In a second additional aspect, alone or in combination with the first aspect, the duration that each BWP in the sequence of BWPs is configured to be the active BWP is defined by a quantity of transmission time intervals, defined by a quantity of milliseconds, or a function of a subcarrier spacing.

In a third additional aspect, alone or in combination with one or more of the first and second aspects, the duration that each BWP in the sequence of BWPs is configured to be the active BWP is defined by a fixed time unit that applies to each BWP in the sequence of BWPs indicated by the BWP switching pattern.

In a fourth additional aspect, alone or in combination with one or more of the first through third aspects, each BWP in the sequence of BWPs is associated with a respective configuration, among multiple configurations, for a single BWP.

In a fifth additional aspect, alone or in combination with one or more of the first through fourth aspects, receiving the information that configures the periodic BWP switching pattern includes receiving, from the network node, RRC signaling that configures multiple periodic BWP switching patterns, and receiving, from the network node, DCI that indicates, among the multiple periodic BWP switching patterns, the periodic BWP switching pattern to use to communicate with the network node.

In a sixth additional aspect, alone or in combination with one or more of the first through fifth aspects, each of the multiple periodic BWP switching patterns is associated with a respective identifier, and wherein the DCI includes a field that indicates the respective identifier associated with the periodic BWP switching pattern to use to communicate with the network node.

In a seventh additional aspect, alone or in combination with one or more of the first through sixth aspects, the sequence of BWPs includes a flexible BWP associated with a dynamic TDD pattern.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, by a network node that supports a network state indication via a BWP framework in accordance with the present disclosure. Example process 600 is an example where the network node (for example, network node 110) performs operations associated with indicating a network state via a BWP framework.

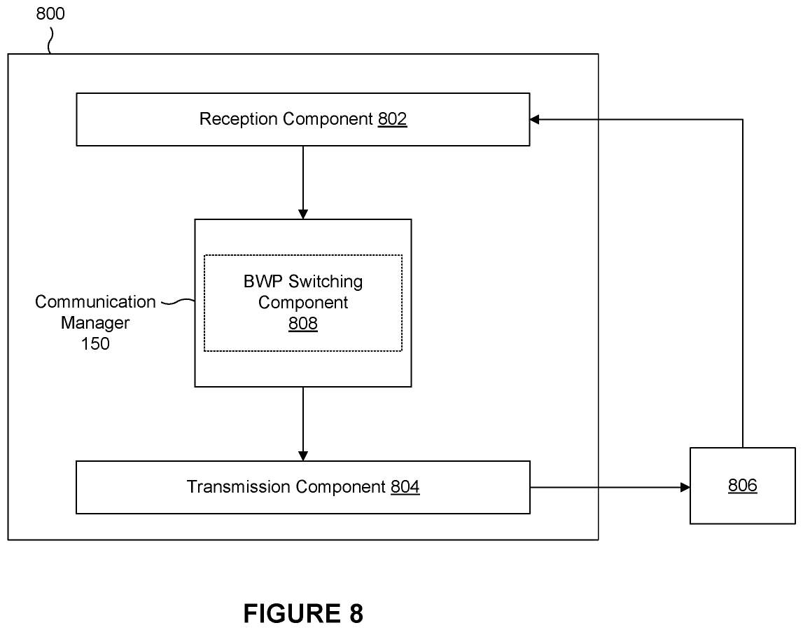

As shown in FIG. 6, in some aspects, process 600 may include transmitting, to a UE, information that configures a periodic BWP switching pattern that indicates a sequence of BWPs, wherein each BWP in the sequence of BWPs is associated with a respective network state (block 610). For example, the network node (such as by using communication manager 150 or transmission component 80, depicted in FIG. 8) may transmit, to a UE, information that configures a periodic BWP switching pattern that indicates a sequence of BWPs, wherein each BWP in the sequence of BWPs is associated with a respective network state, as described above.

As further shown in FIG. 6, in some aspects, process 600 may include communicating with the UE according to the periodic BWP switching pattern, wherein communicating with the UE includes: sequentially switching among the BWPs in the sequence of BWPs indicated in the periodic BWP switching pattern, wherein each BWP used to communicate with the UE is associated with a configuration corresponding to the respective network state associated with the BWP (block 620). For example, the network node (such as by using communication manager 150, reception component 802, transmission component 804, and/or BWP switching component 808, depicted in FIG. 8) may communicate with the UE according to the periodic BWP switching pattern, wherein communicating with the UE includes: sequentially switching among the BWPs in the sequence of BWPs indicated in the periodic BWP switching pattern, wherein each BWP used to communicate with the UE is associated with a configuration corresponding to the respective network state associated with the BWP, as described above.

Process 600 may include additional aspects, such as any single aspect or any combination of aspects described below or in connection with one or more other processes described elsewhere herein.

In a first additional aspect, the periodic BWP switching pattern indicates respective durations that each BWP in the sequence of BWPs is configured to be an active BWP.

In a second additional aspect, alone or in combination with the first aspect, the duration that each BWP in the sequence of BWPs is configured to be the active BWP is defined by a quantity of transmission time intervals, defined by a quantity of milliseconds, or a function of a subcarrier spacing.

In a third additional aspect, alone or in combination with one or more of the first and second aspects, the duration that each BWP in the sequence of BWPs is configured to be the active BWP is defined by a fixed time unit that applies to each BWP in the sequence of BWPs indicated by the BWP switching pattern.

In a fourth additional aspect, alone or in combination with one or more of the first through third aspects, each BWP in the sequence of BWPs is associated with a respective configuration, among multiple configurations, for a single BWP.

In a fifth additional aspect, alone or in combination with one or more of the first through fourth aspects, transmitting the information that configures the periodic BWP switching pattern includes transmitting, to the UE, RRC signaling that configures multiple periodic BWP switching patterns, and transmitting, to the UE, DCI that indicates, among the multiple periodic BWP switching patterns, the periodic BWP switching pattern to use to communicate with the network node.

In a sixth additional aspect, alone or in combination with one or more of the first through fifth aspects, each of the multiple periodic BWP switching patterns is associated with a respective identifier, and wherein the DCI includes a field that indicates the respective identifier associated with the periodic BWP switching pattern to use to communicate with the network node.

In a seventh additional aspect, alone or in combination with one or more of the first through sixth aspects, the sequence of BWPs includes a flexible BWP associated with a dynamic TDD pattern.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports a network state indication via a BWP framework in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to perform one or more operations described herein in connection with FIG. 4. Additionally or alternatively, the apparatus 700 may be configured to perform one or more processes described herein, such as process 500 of FIG. 5. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, a modem, a demodulator, a MIMO detector, a receive processor, a controller/processor, and/or a memory of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, and/or a memory of the UE described above in connection with FIG. 2. In some aspects, the transmission component 704 may be co-located with the reception component 702 in a transceiver.

The communication manager 140 may receive or may cause the reception component 702 to receive, from a network node, information that configures a periodic BWP switching pattern that indicates a sequence of BWPs, wherein each BWP in the sequence of BWPs is associated with a respective network state. The communication manager 140 may communicate with the network node according to the periodic BWP switching pattern, wherein communicating with the network node includes sequentially switching among the BWPs in the sequence of BWPs indicated in the periodic BWP switching pattern, wherein each BWP used to communicate with the network node is associated with a configuration corresponding to the respective network state associated with the BWP. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a BWP switching component 708. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive, from a network node, information that configures a periodic BWP switching pattern that indicates a sequence of BWPs, wherein each BWP in the sequence of BWPs is associated with a respective network state. The reception component 802 and/or the transmission component 804 may communicate with the network node according to the periodic BWP switching pattern. To communicate with the network node, the BWP switching component 808 may sequentially switch among the BWPs in the sequence of BWPs indicated in the periodic BWP switching pattern, wherein each BWP used to communicate with the network node is associated with a configuration corresponding to the respective network state associated with the BWP.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports a network state indication via a BWP framework in accordance with the present disclosure. The apparatus 800 may be a network node, or a network node may include the apparatus 800. In some aspects, the apparatus 800 includes a reception component 802, a transmission component 804, and a communication manager 150, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to perform one or more operations described herein in connection with FIG. 4. Additionally or alternatively, the apparatus 800 may be configured to perform one or more processes described herein, such as process 600 of FIG. 6. In some aspects, the apparatus 800 may include one or more components of the network node described above in connection with FIG. 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, and/or a memory of the network node described above in connection with FIG. 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, and/or a memory of the network node described above in connection with FIG. 2. In some aspects, the transmission component 804 may be co-located with the reception component 802 in a transceiver.

The communication manager 150 may transmit or may cause the transmission component 804 to transmit, to a UE, information that configures a periodic BWP switching pattern that indicates a sequence of BWPs, wherein each BWP in the sequence of BWPs is associated with a respective network state. The communication manager 150 may communicate with the UE according to the periodic BWP switching pattern, wherein communicating with the UE includes sequentially switching among the BWPs in the sequence of BWPs indicated in the periodic BWP switching pattern, wherein each BWP used to communicate with the UE is associated with a configuration corresponding to the respective network state associated with the BWP. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a BWP switching component 808. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 804 may transmit, to a UE, information that configures a periodic BWP switching pattern that indicates a sequence of BWPs, wherein each BWP in the sequence of BWPs is associated with a respective network state. The reception component 802 and/or the transmission component 804 may communicate with the UE according to the periodic BWP switching pattern. To communicate with the UE, the BWP switching component 808 may sequentially switch among the BWPs in the sequence of BWPs indicated in the periodic BWP switching pattern, wherein each BWP used to communicate with the UE is associated with a configuration corresponding to the respective network state associated with the BWP.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving, from a network node, information that configures a periodic BWP switching pattern that indicates a sequence of BWPs, wherein each BWP in the sequence of BWPs is associated with a respective network state; and communicating with the network node according to the periodic BWP switching pattern, wherein communicating with the network node includes: sequentially switching among the BWPs in the sequence of BWPs indicated in the periodic BWP switching pattern, wherein each BWP used to communicate with the network node is associated with a configuration corresponding to the respective network state associated with the BWP.

Aspect 2: The method of Aspect 1, wherein the periodic BWP switching pattern indicates respective durations that each BWP in the sequence of BWPs is configured to be an active BWP.

Aspect 3: The method of Aspect 2, wherein the duration that each BWP in the sequence of BWPs is configured to be the active BWP is defined by a quantity of transmission time intervals, defined by a quantity of milliseconds, or a function of a subcarrier spacing.

Aspect 4: The method of Aspect 2, wherein the duration that each BWP in the sequence of BWPs is configured to be the active BWP is defined by a fixed time unit that applies to each BWP in the sequence of BWPs indicated by the BWP switching pattern.

Aspect 5: The method of any of Aspects 1-4, wherein each BWP in the sequence of BWPs is associated with a respective configuration, among multiple configurations, for a single BWP.

Aspect 6: The method of any of Aspects 1-5, wherein receiving the information that configures the periodic BWP switching pattern includes: receiving, from the network node, RRC signaling that configures multiple periodic BWP switching patterns; and receiving, from the network node, DCI that indicates, among the multiple periodic BWP switching patterns, the periodic BWP switching pattern to use to communicate with the network node.

Aspect 7: The method of Aspect 6, wherein each of the multiple periodic BWP switching patterns is associated with a respective identifier, and wherein the DCI includes a field that indicates the respective identifier associated with the periodic BWP switching pattern to use to communicate with the network node.

Aspect 8: The method of any of Aspects 1-7, wherein the sequence of BWPs includes a flexible BWP associated with a dynamic TDD pattern.

Aspect 9: A method of wireless communication performed by a network node, comprising: transmitting, to a UE, information that configures a periodic BWP switching pattern that indicates a sequence of BWPs, wherein each BWP in the sequence of BWPs is associated with a respective network state; and communicating with the UE according to the periodic BWP switching pattern, wherein communicating with the UE includes: sequentially switching among the BWPs in the sequence of BWPs indicated in the periodic BWP switching pattern, wherein each BWP used to communicate with the UE is associated with a configuration corresponding to the respective network state associated with the BWP.

Aspect 10: The method of Aspect 9, wherein the periodic BWP switching pattern indicates respective durations that each BWP in the sequence of BWPs is configured to be an active BWP.

Aspect 11: The method of Aspect 10, wherein the duration that each BWP in the sequence of BWPs is configured to be the active BWP is defined by a quantity of transmission time intervals, defined by a quantity of milliseconds, or a function of a subcarrier spacing.

Aspect 12: The method of Aspect 10, wherein the duration that each BWP in the sequence of BWPs is configured to be the active BWP is defined by a fixed time unit that applies to each BWP in the sequence of BWPs indicated by the BWP switching pattern.

Aspect 13: The method of any of Aspects 9-12, wherein each BWP in the sequence of BWPs is associated with a respective configuration, among multiple configurations, for a single BWP.

Aspect 14: The method of any of Aspects 9-13, wherein transmitting the information that configures the periodic BWP switching pattern includes: transmitting, to the UE, RRC signaling that configures multiple periodic BWP switching patterns; and transmitting, to the UE, DCI that indicates, among the multiple periodic BWP switching patterns, the periodic BWP switching pattern to use to communicate with the network node.

Aspect 15: The method of Aspect 14, wherein each of the multiple periodic BWP switching patterns is associated with a respective identifier, and wherein the DCI includes a field that indicates the respective identifier associated with the periodic BWP switching pattern to use to communicate with the network node.

Aspect 16: The method of any of Aspects 9-15, wherein the sequence of BWPs includes a flexible BWP associated with a dynamic TDD pattern.

Aspect 17: An apparatus for wireless communication at a device, comprising a processor; memory coupled with the processor; and instructions stored in the memory and executable by the processor to cause the apparatus to perform the method of one or more of Aspects 1-8.

Aspect 18: A device for wireless communication, comprising a memory and one or more processors coupled to the memory, the one or more processors configured to perform the method of one or more of Aspects 1-8.

Aspect 19: An apparatus for wireless communication, comprising at least one means for performing the method of one or more of Aspects 1-8.

Aspect 20: A non-transitory computer-readable medium storing code for wireless communication, the code comprising instructions executable by a processor to perform the method of one or more of Aspects 1-8.

Aspect 21: A non-transitory computer-readable medium storing a set of instructions for wireless communication, the set of instructions comprising one or more instructions that, when executed by one or more processors of a device, cause the device to perform the method of one or more of Aspects 1-8.

Aspect 22: An apparatus for wireless communication at a device, comprising a processor; memory coupled with the processor; and instructions stored in the memory and executable by the processor to cause the apparatus to perform the method of one or more of Aspects 9-16.

Aspect 23: A device for wireless communication, comprising a memory and one or more processors coupled to the memory, the one or more processors configured to perform the method of one or more of Aspects 9-16.

Aspect 24: An apparatus for wireless communication, comprising at least one means for performing the method of one or more of Aspects 9-16.

Aspect 25: A non-transitory computer-readable medium storing code for wireless communication, the code comprising instructions executable by a processor to perform the method of one or more of Aspects 9-16.

Aspect 26: A non-transitory computer-readable medium storing a set of instructions for wireless communication, the set of instructions comprising one or more instructions that, when executed by one or more processors of a device, cause the device to perform the method of one or more of Aspects 9-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of”: a, b, or c is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive, from a network node, information that configures a periodic bandwidth part (BWP) switching pattern that indicates a sequence of BWPs, wherein each BWP in the sequence of BWPs is associated with a respective network state; and
communicate with the network node according to the periodic BWP switching pattern, wherein, to cause the UE to communicate with the network node, the at least one processor is configured to cause the UE to:
sequentially switch among the BWPs in the sequence of BWPs indicated in the periodic BWP switching pattern, wherein each BWP used to communicate with the network node is associated with a configuration corresponding to the respective network state associated with the BWP.

2. The UE of claim 1, wherein the periodic BWP switching pattern indicates respective durations that each BWP in the sequence of BWPs is configured to be an active BWP.

3. The UE of claim 2, wherein the duration that each BWP in the sequence of BWPs is configured to be the active BWP is defined by a quantity of transmission time intervals, defined by a quantity of milliseconds, or a function of a subcarrier spacing.

4. The UE of claim 2, wherein the duration that each BWP in the sequence of BWPs is configured to be the active BWP is defined by a fixed time unit that applies to each BWP in the sequence of BWPs indicated by the BWP switching pattern.

5. The UE of claim 1, wherein each BWP in the sequence of BWPs is associated with a respective configuration, among multiple configurations, for a single BWP.

6. The UE of claim 1, wherein, to cause the UE to receive the information that configures the periodic BWP switching pattern, the at least one processor is configured to cause the UE to:
receive, from the network node, radio resource control (RRC) signaling that configures multiple periodic BWP switching patterns; and
receive, from the network node, downlink control information (DCI) that indicates, among the multiple periodic BWP switching patterns, the periodic BWP switching pattern to use to communicate with the network node.

7. The UE of claim 6, wherein each of the multiple periodic BWP switching patterns is associated with a respective identifier, and wherein the DCI includes a field that indicates the respective identifier associated with the periodic BWP switching pattern to use to communicate with the network node.

8. The UE of claim 1, wherein the sequence of BWPs includes a flexible BWP associated with a dynamic time division duplexing (TDD) pattern.

9. A network node for wireless communication, comprising:
at least one memory; and
at least one processor communicatively coupled with the at least one memory, the at least one processor configured to cause the network node to:
transmit, to a user equipment (UE), information that configures a periodic bandwidth part (BWP) switching pattern that indicates a sequence of BWPs, wherein each BWP in the sequence of BWPs is associated with a respective network state; and
communicate with the UE according to the periodic BWP switching pattern, wherein, to cause the network node to communicate with the UE, the at least one processor is configured to cause the network node to:
sequentially switch among the BWPs in the sequence of BWPs indicated in the periodic BWP switching pattern, wherein each BWP used to communicate with the UE is associated with a configuration corresponding to the respective network state associated with the BWP.

10. The network node of claim 9, wherein the periodic BWP switching pattern indicates respective durations that each BWP in the sequence of BWPs is configured to be an active BWP.

11. The network node of claim 10, wherein the duration that each BWP in the sequence of BWPs is configured to be the active BWP is defined by a quantity of transmission time intervals, defined by a quantity of milliseconds, or a function of a subcarrier spacing.

12. The network node of claim 10, wherein the duration that each BWP in the sequence of BWPs is configured to be the active BWP is defined by a fixed time unit that applies to each BWP in the sequence of BWPs indicated by the BWP switching pattern.

13. The network node of claim 9, wherein each BWP in the sequence of BWPs is associated with a respective configuration, among multiple configurations, for a single BWP.

14. The network node of claim 9, wherein, to cause the network node to transmit the information that configures the periodic BWP switching pattern, the at least one processor is configured to cause the network node to:
transmit, to the UE, radio resource control (RRC) signaling that configures multiple periodic BWP switching patterns; and
transmit, to the UE, downlink control information (DCI) that indicates, among the multiple periodic BWP switching patterns, the periodic BWP switching pattern to use to communicate with the network node.

15. The network node of claim 14, wherein each of the multiple periodic BWP switching patterns is associated with a respective identifier, and wherein the DCI includes a field that indicates the respective identifier associated with the periodic BWP switching pattern to use to communicate with the network node.

16. The network node of claim 9, wherein the sequence of BWPs includes a flexible BWP associated with a dynamic time division duplexing (TDD) pattern.

17. A method of wireless communication performed by a user equipment (UE), comprising:
receiving, from a network node, information that configures a periodic bandwidth part (BWP) switching pattern that indicates a sequence of BWPs, wherein each BWP in the sequence of BWPs is associated with a respective network state; and
communicating with the network node according to the periodic BWP switching pattern, wherein communicating with the network node includes:
sequentially switching among the BWPs in the sequence of BWPs indicated in the periodic BWP switching pattern, wherein each BWP used to communicate with the network node is associated with a configuration corresponding to the respective network state associated with the BWP.

18. The method of claim 17, wherein the periodic BWP switching pattern indicates respective durations that each BWP in the sequence of BWPs is configured to be an active BWP.

19. The method of claim 18, wherein the duration that each BWP in the sequence of BWPs is configured to be the active BWP is defined by a quantity of transmission time intervals, defined by a quantity of milliseconds, or a function of a subcarrier spacing.

20. The method of claim 18, wherein the duration that each BWP in the sequence of BWPs is configured to be the active BWP is defined by a fixed time unit that applies to each BWP in the sequence of BWPs indicated by the BWP switching pattern.

21. The method of claim 17, wherein each BWP in the sequence of BWPs is associated with a respective configuration, among multiple configurations, for a single BWP.

22. The method of claim 17, wherein receiving the information that configures the periodic BWP switching pattern includes:
receiving, from the network node, radio resource control (RRC) signaling that configures multiple periodic BWP switching patterns; and
receiving, from the network node, downlink control information (DCI) that indicates, among the multiple periodic BWP switching patterns, the periodic BWP switching pattern to use to communicate with the network node.

23. The method of claim 17, wherein the sequence of BWPs includes a flexible BWP associated with a dynamic time division duplexing (TDD) pattern.

24. A method of wireless communication performed by a network node, comprising:
transmitting, to a user equipment (UE), information that configures a periodic bandwidth part (BWP) switching pattern that indicates a sequence of BWPs, wherein each BWP in the sequence of BWPs is associated with a respective network state; and
communicating with the UE according to the periodic BWP switching pattern, wherein communicating with the UE includes:
sequentially switching among the BWPs in the sequence of BWPs indicated in the periodic BWP switching pattern, wherein each BWP used to communicate with the UE is associated with a configuration corresponding to the respective network state associated with the BWP.

25. The method of claim 24, wherein the periodic BWP switching pattern indicates respective durations that each BWP in the sequence of BWPs is configured to be an active BWP.

26. The method of claim 25, wherein the duration that each BWP in the sequence of BWPs is configured to be the active BWP is defined by a quantity of transmission time intervals, defined by a quantity of milliseconds, or a function of a subcarrier spacing.

27. The method of claim 25, wherein the duration that each BWP in the sequence of BWPs is configured to be the active BWP is defined by a fixed time unit that applies to each BWP in the sequence of BWPs indicated by the BWP switching pattern.

28. The method of claim 24, wherein each BWP in the sequence of BWPs is associated with a respective configuration, among multiple configurations, for a single BWP.

29. The method of claim 24, wherein transmitting the information that configures the periodic BWP switching pattern includes:
transmitting, to the UE, radio resource control (RRC) signaling that configures multiple periodic BWP switching patterns; and
transmitting, to the UE, downlink control information (DCI) that indicates, among the multiple periodic BWP switching patterns, the periodic BWP switching pattern to use to communicate with the network node.

30. The method of claim 24, wherein the sequence of BWPs includes a flexible BWP associated with a dynamic time division duplexing (TDD) pattern.
